(19) United States
(12) Patent Application Publication
(10) Pub. No.: US 2009/0132375 A1
(43) Pub. Date: May 21, 2009

(54) System for allocating rebates in conjunction with a product

(75) Inventor: Chad Dustin Weathersby, Cypress, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: 6DGR, Inc.

(21) Appl. No.: 12/286,746

(22) Filed: Sep. 30, 2008

Related U.S. Application Data
(60) Provisional application No. 60/997,468, filed on Oct. 2, 2007.

(51) Int. Cl. G06Q 30/00; G06Q 40/00

(52) U.S. Cl. 705/14

(57) ABSTRACT

A system is provided for allocating rebates in conjunction with a product. The system comprises (a) a network which includes sets of members Mₙ, Mₙ₊₁ and Mₙ₊₂, wherein each member of Mₙ₊₁ has subscribed to the product through a member of Mₙ, and wherein each member of Mₙ₊₂ has subscribed to the product through a member of Mₙ₊₁; and (b) a rebate allocation system which allocates rebates to members of the network such that a first rebate is allocated to a member mₓεMₙ for each member m_{xy}εSₓ that has subscribed to the product through member mₓ, wherein Sₓ⊂Mₙ₊₁, and such that a second rebate is allocated to member mₓ for each member m_{xyz}εS_{xy} that has subscribed to the product through member m_{xy}, wherein S_{xy}⊂Mₙ₊₂.

### CROSS-REFERENCE TO RELATED APPLICATIONS

This application claims priority to U.S. Ser. No. 60/997,468, entitled “SYSTEM FOR LEVERAGING SOCIAL NETWORKS TO MARKET A FINANCIAL INSTRUMENT”, which was filed on Oct. 2, 2007, and which is incorporated herein by reference in its entirety.

### FIELD OF THE DISCLOSURE

The present disclosure relates generally to social networks, and more particularly to the use of such networks in marketing products.

### BACKGROUND OF THE DISCLOSURE

Social networks are social structures which consist of a plurality of nodes (typically individuals or organizations) which are tied together by one or more specific types of relations. These relations may include, for example, shared values or ideas, friendship, kinship, a common trade, financial exchange, and the like.

In a social network, social relationships may be expressed in terms of nodes and ties, where nodes are the individual actors within the network, and ties are the relationships between the actors. In its simplest form, a social network is a map of all of the relevant ties between the nodes.

### SUMMARY OF THE DISCLOSURE

In one aspect, a method is provided for marketing a product in conjunction with a network. The network includes sets of members Mₙ, Mₙ₊₁, and Mₙ₊₂, wherein each member of Mₙ₊₁ has subscribed to the product through a member of Mₙ, and wherein each member of Mₙ₊₂ has subscribed to the product through a member of Mₙ₊₁. A first rebate is provided to a member mₓεMₙ for each member m_{xy}εSₓ that has subscribed to the product through member mₓ, wherein Sₓ⊂Mₙ₊₁, and a second rebate is provided to member mₓ for each member m_{xy}εS_{xy} that has subscribed to the product through member m_{xy}, wherein S_{xy}⊂Mₙ₊₂.

In another aspect, a method for marketing a product in conjunction with a network is provided. The network includes first, second and third sets of members, wherein each member of the second set subscribes to the product through a member of the first set, and wherein each member of the third set subscribes to the product through a member of the second set. A first rebate is provided to a member of the first set for each member of the second set that subscribes to the product through that member of the first set, and a second rebate is provided to a member of the second set for each member of the third set that subscribes to the product through that member of the second set.

In a further aspect, a method for marketing a product in conjunction with a network is provided. The network includes a member mₓ and sets of members Mₙ₊₁, and Mₙ₊₂, wherein Mₙ₊₁ is the set of network members who have subscribed to the product through mₓ, and wherein Mₙ₊₂ is the set of network members who have subscribed to the product through a member of Mₙ₊₁. A first rebate is provided to mₓ for each member of Mₙ₊₁, and a second rebate is provided to mₓ for each member of Mₙ₊₂.

In yet another aspect, a system for allocating rebates in conjunction with a network is provided. The network includes sets of members Mₙ, Mₙ₊₁ and Mₙ₊₂, wherein each member of Mₙ₊₁ has subscribed to a product through a member of Mₙ, and wherein each member of Mₙ₊₂ has subscribed to the product through a member of Mₙ₊₁. A rebate allocation system allocates rebates to members of the network such that a first rebate is allocated to a member mₓ εMₙ for each member m_{xy}εSₓ that has subscribed to the product through member mₓ, wherein Sₓ⊂Mₙ₊₁, and such that a second rebate is allocated to member mₓ for each member m_{xy}εS_{xy} that has subscribed to the product through member m_{xy} wherein S_{xy}⊂Mₙ₊₂.

In still another aspect, a system for allocating rebates in conjunction with a network is provided. The network includes first, second and third sets of members, wherein each member of the second set subscribes to a product through a member of the first set, and wherein each member of the third set subscribes to the product through a member of the second set. A rebate allocation system allocates rebates to members of the network such that a first rebate is allocated to a member of the first set for each member of the second set that subscribes to the product through that member of the first set, and such that a second rebate is allocated to a member of the second set for each member of the third set that subscribes to the product through that member of the second set.

In a further aspect, a method is provided for targeting advertising over a network, wherein members of the network can subscribe to a product, and wherein subscription to the product requires the provision of authenticated demographic data pertaining to the subscribing member. In accordance with the method, the demographic data is utilized to target advertising to members of the network, preferably on a real-time basis.

In yet another aspect, a method for targeting advertisements to users of a network is provided. A database is provided which has a plurality of advertisements associated therewith, wherein the plurality of advertisements includes a first advertisement which is targeted to a first demographic group. A fingerprint is assigned to each user, wherein each fingerprint comprises demographic information relating to the user which has been verified through a subscription to a product. The first advertisement is rendered to users who are members of the first demographic group. The plurality of advertisements may also include a second advertisement which is targeted to a second demographic group, wherein the first and second advertisements are distinct, and wherein the first and second demographic groups are distinct.

In still another aspect, a system for targeting advertisements to users of a network is provided. The system comprises (a) a first database having a plurality of advertisements associated therewith, wherein the plurality of advertisements includes a first advertisement which is targeted to a first demographic group; (b) a second database having a plurality of fingerprints associated therewith, wherein each fingerprint comprises demographic information, relating to a user of the network, which has been verified through a subscription to a product; and (c) software adapted to render the first advertisement to users who are members of the first demographic group. The plurality of advertisements may also include a second advertisement which is targeted to a second demographic group, wherein the first and second advertisements are distinct, and wherein the first and second demographic groups are distinct.

In any of the foregoing aspects, the product is preferably a financial instrument, but more generally may be selected from the group consisting of financial instruments, goods and services. Moreover, the systems or methodologies in the foregoing aspects may include the product or the step of providing the product, and may also include a network or the step of providing a network. Further features of the foregoing aspects may be found in Appendix A, which forms part of the present specification.

### BRIEF DESCRIPTION OF THE DRAWINGS

FIG. 1 is an illustration of a network in accordance with the teachings herein.

FIG. 2 is a screenshot from one embodiment of a website adapted to implement the methodologies described herein.

FIG. 3 is a screenshot from one embodiment of a website adapted to implement the methodologies described herein.

FIG. 4 is a screenshot from one embodiment of a website adapted to implement the methodologies described herein.

FIG. 5 is a screenshot from one embodiment of a website adapted to implement the methodologies described herein.

FIG. 6 is a screenshot from one embodiment of a website adapted to implement the methodologies described herein.

FIG. 7 is a screenshot from one embodiment of a website adapted to implement the methodologies described herein.

FIG. 8 is a screenshot from one embodiment of a website adapted to implement the methodologies described herein.

FIG. 9 is a screenshot from one embodiment of a website adapted to implement the methodologies described herein.

FIG. 10 is a screenshot from one embodiment of a website adapted to implement the methodologies described herein.

FIG. 11 is a screenshot from one embodiment of a website adapted to implement the methodologies described herein.

FIG. 12 is a screenshot from one embodiment of a website adapted to implement the methodologies described herein.

FIG. 13 is a screenshot from one embodiment of a website adapted to implement the methodologies described herein.

FIG. 14 is an illustration of a system for implementing some of the methodologies disclosed herein.

FIG. 15 is an illustration depicting the details of the server of FIG. 14.

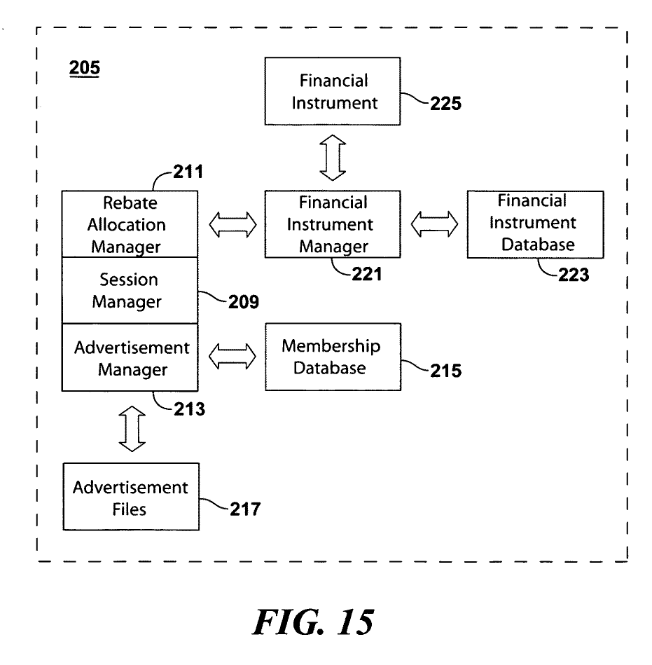

### DETAILED DESCRIPTION

While social networks of various forms have been known for some time, the possibilities of leveraging the unique properties and potential structural hierarchies of social networks for the promotion of products (such as financial instruments, goods or services), and the advantages of using social networks in conjunction with such products for targeted marketing and advertisement, have been largely ignored. Rather, to date, social networks have been treated like any other large group from these perspectives.

For example, the alumni associations of some large universities offer their members the opportunity to obtain a credit card embossed with the university's logo. In some cases, a small percentage of the purchases charged to the card may be donated to the university by the financial institution sponsoring the card. However, the process of marketing the card typically falls to the financial institution itself, with little or no help from the alumni association or its constituents. Moreover, the opportunities to utilize the card (and the information obtained through subscription to the card) as a vehicle for targeted marketing and advertising (especially on a real-time basis) are typically ignored.

There thus exists a need in the art for systems and methods which overcome these infirmities. In particular, there is a need in the art for systems and methods of marketing products (such as financial instruments, goods or services) which leverage the unique properties and potential hierarchies of social networks, and which provide for targeted marketing and advertising (especially on a real-time basis) utilizing the information obtained from members of the network through subscription to the products. These and other needs are met by the systems and methodologies disclosed herein.

The systems and methodologies described herein provide a means for effectively utilizing social networks to market products, especially financial instruments such as credit cards, debit cards, mortgages, bank accounts and consumer loans. This may be accomplished, for example, by associating the product with the network and by utilizing subscription-based incentives to encourage members of the network to solicit new subscribers to the product. Such incentives may be implemented by requiring that the product be subscribed through an existing member of the network, and by rewarding members of the network when subscriptions to the product are made through them.

As a specific example, members who successfully facilitate a subscription to the product may receive an initiation fee, a percentage of the interest received on the product (in the case, for example, when the product is a consumer loan), or a percentage of the value of goods or services purchased with the product (in the case, for example, when the product is a credit card). Various treeing or pyramid schemes may also be employed to reward members when subscribers they have cultivated successfully solicit further subscribers.

The combination of a social network and a product of the type described above provides unique opportunities for targeted marketing and advertisement. In particular, the product, especially if it is a financial instrument, may be leveraged as a means to obtain verified demographic information about members of the network. Due to its greater reliability, such verified demographic information is generally much more valuable to advertisers than unverified demographic information of the type that might be obtained through voluntary or anonymous feedback or polls. In addition, the use of this information allows merchants and advertisers to direct their efforts to members of the public who are much more likely to be interested in their products and services, thereby achieving a greater return on their advertising dollars and efforts.

Moreover, such targeted marketing and advertisement may be implemented on a real-time basis when a user of the social network is determined to be online (as, for example, when the user is logged onto the social networking site, or is actively browsing the site). This allows the management of the network to deliver to advertisers those users of a desired demographical description who, because of their current online status, are almost certain to see the advertisement. Consequently, the management of the network can demand an advertising premium over the rates prevailing for blanket advertisement. On the other hand, members of the network benefit from the fact that the advertisements they are exposed to are much more likely to be of actual interest to them.

As a further aspect, some or all of the proceeds from the use or (where allowed by law) sale of the demographic information may be distributed among the network members, possibly in accordance with an established hierarchical scheme. This may have the desirable effect of attracting further members to the network and encouraging further efforts on the part of existing members to obtain further subscriptions to sponsored products or to recruit further members to the network. In addition, since they are a potential source of revenue, the presence of advertisements on the network is less likely to be irksome to members of the network.

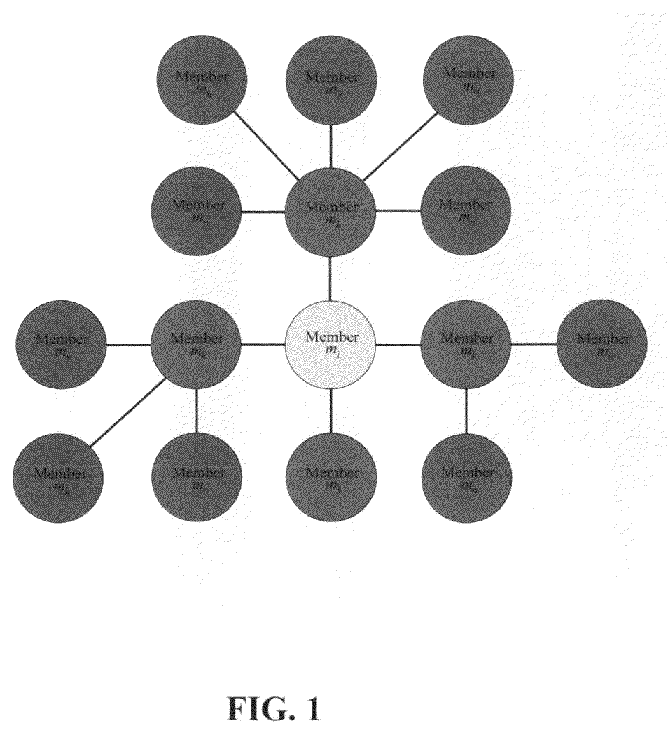

The hierarchy of the networks described herein may be further understood with respect to the particular, non-limiting embodiment of the network map depicted in FIG. 1. As seen therein, the network contains primary nodes represented by member mₓ, secondary nodes represented by members m_{xy}, and tertiary nodes represented by members m_{xyz}. For the sake of simplicity, only three levels in the network have been depicted, although it will be appreciated that the network may contain any number of levels. Similarly, only a single primary node has been illustrated, although it will be appreciated that the network may contain any number of primary nodes which may have their own sets of ties to secondary and tertiary levels, and possibly beyond.

The associations in the network may be determined with respect to one or more products sponsored by the network. In the present example, these products are financial instruments which may be, for example, credit cards, debit cards, mortgages, consumer loans, lines of credit, or any other such instruments. The primary nodes mₓ achieve their status at the top of the network hierarchy (as it relates to a financial instrument) by belonging to the first group of network members to solicit subscriptions to the financial instrument. Preferably, the primary nodes will themselves have either subscribed to the financial instrument they are seeking subscriptions to, or will have subscribed to another financial instrument sponsored by the network.

Each secondary node m_{xy} is related to a primary node mₓ by way of subscription to a financial instrument through mₓ. Similarly, each tertiary node m_{xyz} is related to a secondary node m_{xy} by way of subscription to a financial instrument through m_{xy}. The network hierarchy may continue indefinitely in this manner, with each node at a given level in the hierarchy being related or tied to a node at the next higher level of the hierarchy through subscription to a financial instrument which is sponsored by the network.

One significant feature of some of the systems and methodologies described herein relates to the implementation of a payout scheme in relation to a financial instrument or other product, and across a network hierarchy. In a preferred embodiment, this payout scheme assumes the form of a rebate which is applied across the hierarchical structure. By way of example, and with reference again to the example depicted in FIG. 1, if the financial instrument is a debit card, a customer acquisition rebate may be awarded when a member of the network subscribes to the card. Preferably, subscription to the card can only occur through another cardholder in the network. Thus, for example, if member mₓ₂₂ subscribes to the card through member mₓ₂, then a first customer acquisition rebate may be applied in the form of a rebate to the debit card held by member mₓ₂. Preferably, a second customer acquisition rebate is also applied to a debit card held by member mₓ. By applying the rebates across the network hierarchy in this manner, each member of the network has a financial incentive to cultivate additional card subscriptions.

The payback schemes which may be utilized in conjunction with some of the systems and methodologies disclosed herein are not limited to customer acquisition rebates. Returning to the previous example, if member mₓ₂₂ subscribes to a debit card through member mₓ₂, then a percentage of all purchases (a “percent of spend”) charged to the card (and/or a percentage of the interest and/or fees earned on the card) may be applied in the form of a rebate to a debit card held by member mₓ₂. Preferably, a percentage of all purchases, interest and/or fees associated with the card are also applied to the debit card held by member mₓ in the form of a rebate. By way of example, member mₓ₂ may receive a rebate in the amount of 1% of all the purchases charged to the card, while member mₓ may receive a rebate in the amount of 0.5% of all the purchases charged to the card. It will thus be appreciated that the financial incentive to members of the network to market financial instruments sponsored by the network can be quite significant, and will be a function not only of the number of subscriptions that they successfully cultivate, but also of the number of subscriptions successfully cultivated by members lower in the hierarchy and having ties to them.

The payback schemes which may be utilized in conjunction with the systems and methodologies disclosed herein are also not limited to payment of a rebate in the form of a credit appearing on a debit or credit card. For example, in some embodiments, the rebate may take the form of frequent flier miles, cell phone or long distance minutes, travel or lodging discounts, coupons, gift certificates, or credits that are redeemable towards the purchase of various goods or services. In some embodiments, the user may be permitted to select the form his rebates will take, preferably from a predefined list of approved rebate types established by network management.

In some embodiments, the rebates may also be transformable from one type to another by members of the network, and may be negotiable or transferrable between members of the network. Hence, in such embodiments, the rebates may form a type of currency between members of the network or network management.

As previously noted, the systems and methodologies described herein may also be applied to various other products which may not necessarily be financial instruments. Some non-limiting examples of such other products include insurance policies (including, for example, health insurance policies, life insurance policies, and homeowner's insurance policies), telephone subscription packages or minutes, calling cards, gift cards, online subscriptions, online surveys, various retail products, and advertising. Some of these products may have multiple types of rebates associated with them (e.g., “percent of spend” and customer acquisition rebates), while other products may have only one of these rebate types associated with them. Moreover, the rebate may be paid by the network, a merchant or party associated with the instrument, the company offering the instrument (which may be, for example, a credit card company or a bank), the user or purchaser of the instrument, or any combination or subcombination of the foregoing.

In other possible embodiments in accordance with the teachings herein, the form a rebate takes may bear some relationship to the product the user has facilitated a subscription to or sale of. For example, in such embodiments, if a first user is being credited with facilitating the subscription of a second user to a cell phone plan offered by a sponsored merchant, the first user may be assigned a rebate in the form of free cell phone minutes provided by the sponsored merchant. Similarly, if the first user is being credited with facilitating the sale of a travel package to a second user, the first user may be assigned a rebate in the form of frequent flier miles, a credit redeemable towards the rental of a hotel room or automobile, or points which may be redeemed for free or discounted vacation packages.

In a foregoing example, rebates were applied only to the two hierarchical layers directly above a member subscribing to a product (and in particular, to a financial instrument). However, it will be appreciated that rebates can be spread over any number of layers within the hierarchy. Moreover, rebate distributions may be implemented using various functions and algorithms. For example, the distribution may be linear or quadratic, it may follow an nth order polynomial (where n>2), or it may be in the form of various other distributions or functions. The distribution may also be a function of the number of hierarchical layers above the subscriber, or it may be limited to a fixed number of layers. The distribution may also be a function of the particular product in question. Thus, for example, a variety of different financial or non-financial instruments may be associated with the network, and each of these instruments may have its own rebate scheme.

It will also be appreciated that a rebate issued or paid by a given party will not necessarily be distributed in its entirety among the qualifying members of the network. Preferably, a portion of each rebate will be retained by network management to pay for the costs of managing the network. This retained amount may vary from one product to another, and may be in the form, for example, of a percentage of the rebate, a minimum amount, or a maximum amount.

Preferably, in order to receive rebates for cultivating new subscriptions to a product associated with or sponsored by the network, a member of the network must himself have subscribed to a product that is associated with or sponsored by the network. In the case of financial instruments, this requirement is advantageous in that it facilitates the rebate process by providing an instrument which may be credited with the rebates, and also provides an incentive for members of the network to sign up for the initial offering of the product. In some embodiments, this product need not be the same product (or even the same type of product) that the member is being credited for cultivating a subscription to. This feature gives rise to unique marketing opportunities.

In particular, in order to qualify for the product (especially if the product is a financial instrument, such as a credit card or loan), a member of the network will typically have to provide to the party managing the product certain demographic information, such as age, gender, first name, last name, address (including zip code) and financial information. That information (which is typically verified or verifiable) may, in turn, be made available to network management. Hence, through the normal operation of the network, network management will obtain validated demographic information on its members. Because this information is validated, it can be sold or traded (where legal) or otherwise made available for a premium to marketers interested in targeting advertisements to particular demographic groups associated with the network.

Preferably, the validated demographic information is made available to marketers only indirectly. For example, marketers (or third parties associated with them) may provide advertisements to network management along with a description of the demographics the advertisements are targeted at. Network management can then use this information to select members of the network to whom the advertisements are rendered. Consequently, the advertisements can reach their intended audience, without violating the privacy of network members. In some cases, network management may provide advertisers with feedback regarding, for example, how many members of which demographics viewed or clicked on a particular advertisement.

Moreover, the network will preferably be equipped with a login process established to provide secure access to the network. Consequently, network management can provide advertisers with some assurance that the audience targeted by an advertisement displayed on the network will actually view the advertisement. This is especially true if rendering of the advertisement is cued to the online status of users to which the advertisement is directed, or if rendering of the advertisement is cued to login status and an additional event (such as, for example, the user clicking on a certain field or tab). In cases where an advertiser is required to pay a fee for each time that an advertisement is viewed, browsed or clicked on, network management can also provide assurance, through the login process, that each fee generating event is associated with a user fitting the demographics that the advertiser is interested in. In some embodiments, additional premiums may be charged for these features.

It will further be appreciated that a variety of new or hybrid advertisement revenue schemes are possible in accordance with the teachings herein. For example, as noted above, the systems and methodologies described herein provide a unique means for ensuring that a targeted audience views (or, as the case may be, listens to) advertisements for which that audience was intended. By contrast, existing methods of advertising over a network, such as the Internet, utilize blind advertisement schemes, or rely on unverified demographic information. Consequently, even if such advertisements are browsed or clicked on, the advertiser has no way of knowing whether the user is a member of the intended audience.

In some embodiments of the systems and methodologies described herein, an advertiser may be charged a fee which is based on the number of users of a designated demographic who browse an advertisement. The number of such users may be established, for example, by user IDs and passwords input by the users at login, in combination with demographic information gathered from the users in conjunction with an application for a financial instrument or other product as described above. The number of users who browse an advertisement may be established, for example, by browsing history, mouse clicks, or other user-related data or input.

In some embodiments of the systems and methodologies described herein, a portion of the resulting advertising revenue may be apportioned among the users of the network as a whole, among the users who fit the targeted demographic, or among the users who have clicked on, browsed, or viewed the advertisement in question. Such apportionments of revenue may be implemented in accordance with any of the apportionment schemes described above. In other embodiments, the network and/or its members (or certain subsets thereof) may receive a bonus for each user who is targeted by an advertisement and who subsequently purchases the advertised goods or services. Such users may be identified, for example, from information (such as name and address) obtained from the user during the checkout process. In some embodiments, a separate or additional bonus may be granted if the purchase of goods or services is accomplished through the use of a financial instrument sponsored by the network.

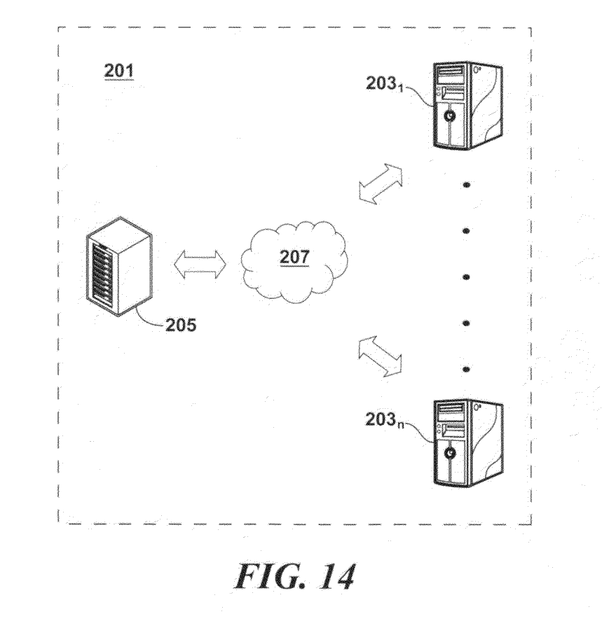

FIG. 14 illustrates a first particular, non-limiting embodiment of a system adapted to implement some of the methodologies described herein. As seen therein, the system 201 consists of a plurality of users 203₁ to 203ₙ who are in communication with a server 205 by way of a suitable network 207. Network 207 is preferably the Internet, but may also be a plurality of networks, and may include a variety of WANs or LANs. Similarly, although server 205 is depicted as a single device, one skilled in the art will appreciate that server 205 may also comprise a plurality of devices, such as a server farm.

Still referring to FIG. 14, server 205 comprises a Session Manager 209. The Session Manager monitors the online status of members of the network 207, and may also handle the login process.

The server 205 further comprises an Advertisement Manager 211. The Advertisement Manager 211 is in communication with the Session Manager 209, and is also in communication with a membership database 215 and a set of advertisement files 217. The advertisement files 217 preferably include the advertisements to be rendered, and information relating to the demographic group (or groups) that the advertisement is to be targeted at. The membership database 215 preferably contains demographic information collected when members of the network 207 subscribe to a product (in this case, a financial instrument 225) sponsored by the network 207.

For each advertisement in the advertisement files 217, the Advertisement Manager 211 compares the specified demographics of the targeted group with the demographic information stored in the membership database 215. As a result of this process, the Advertisement Manager 211 identifies a subset of the members of the network 207 who meet the demographic criteria specified for a particular advertisement.

The Advertisement Manager 211 then queries the Session Monitor 211 to determine whether any of the identified members are online. If so, the Advertisement Manager 211 renders the advertisement stored in the respective advertisement file 217 to each of the identified online members. The advertisement may appear, for example, as a banner or floating advertisement on a web page that the member is browsing. If an identified member is not online, then the Advertisement Manager 211 may either do nothing, or may queue the advertisement for rendering at a later time when the identified member is online (in some embodiments, the queue may have a time limit associated with it so that, for example, the advertisement is purged after a certain date or time period). If a member is online but does not meet the demographic criteria specified in the advertisement file, the Advertisement Manager 211 may render a different advertisement to that member which may be, for example, a generic advertisement.

The server 205 also comprises a Rebate Allocation Manager 213. The Rebate Allocation Manager 213 is in communication with a Financial Instrument Manager 221. The Financial Instrument Manager 221 is a (typically external) entity which manages a financial instrument from which rebates may accrue to members of the network 207. Thus, for example, if the financial instrument 225 is a credit card, the Financial Instrument Manager 221 may be a bank or other financial institution. The Financial Instrument Manager 221 has a financial instrument database 223 associated therewith which tracks transactions associated with the financial instrument that may have rebate implications. The Rebate Allocation Manager 213 cooperates with the Financial Instrument Manager 221 to determine which members of the network 207 are entitled to a rebate, and keeps a record of those members and the amount of the rebate they are entitled to. This information is then communicated to the appropriate members of the network 207. In a preferred embodiment, the rebate information corresponding to a particular member is displayed on a web page accessible by the member, and is updated (either periodically, or when the member logs onto the network 207) to show any changes.

Various modifications may be made to the foregoing system. For example, while the system has been specifically illustrated with respect to a financial instrument, it will be appreciated that similar systems may be implemented for use with other types of products. Moreover, while the server 205 in this particular embodiment is depicted as having certain functionalities incorporated therein (notably, the Rebate Allocation Manager 213, the Session Monitor 211, and the Advertisement Manager 211), any or all of these functions may instead be implemented as separate modules or devices. Similarly, in some embodiments, the Advertisement Files 217 may reside on one or more external servers or devices, or may be served up on demand as a service by an external party.

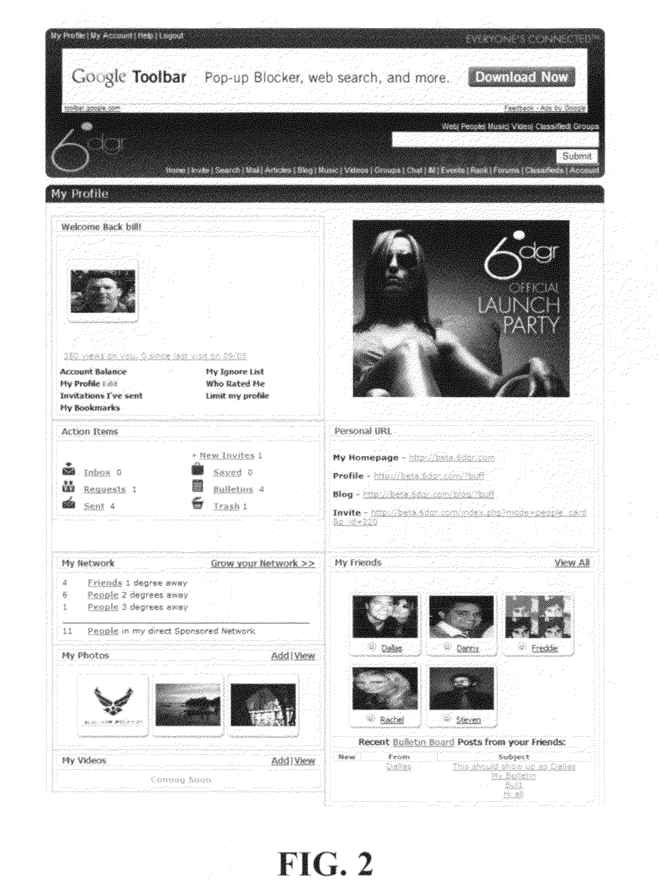

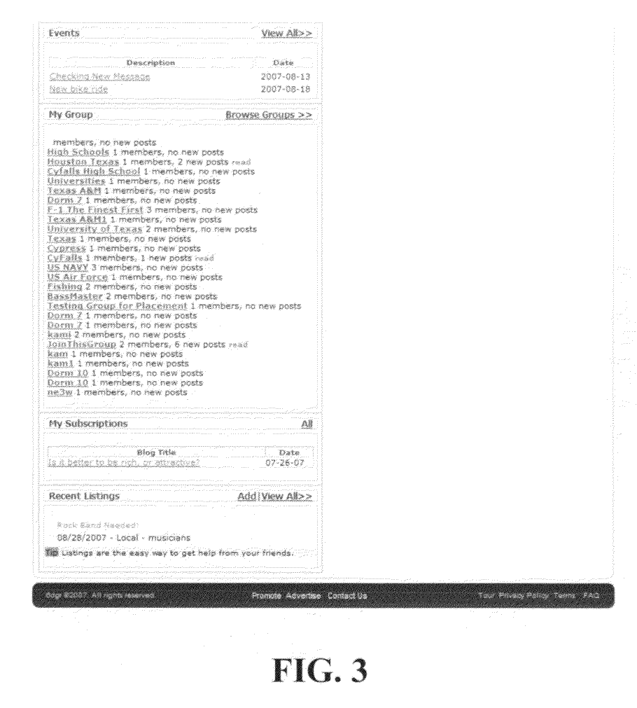

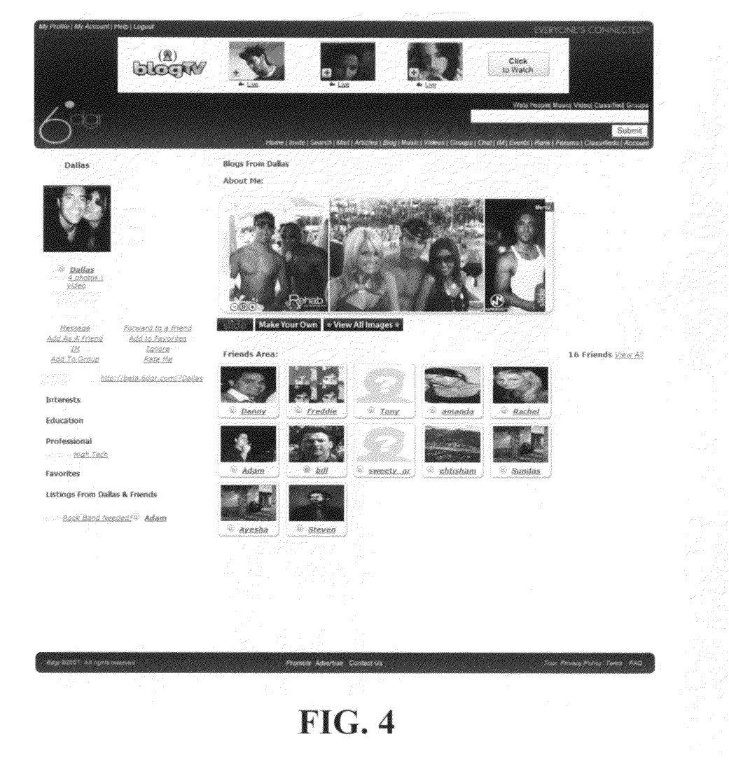

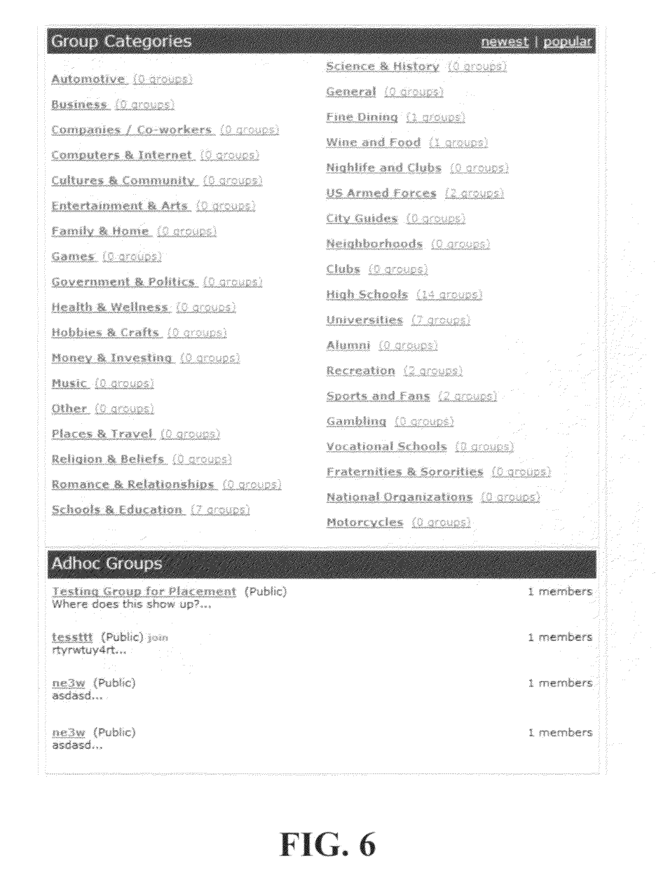

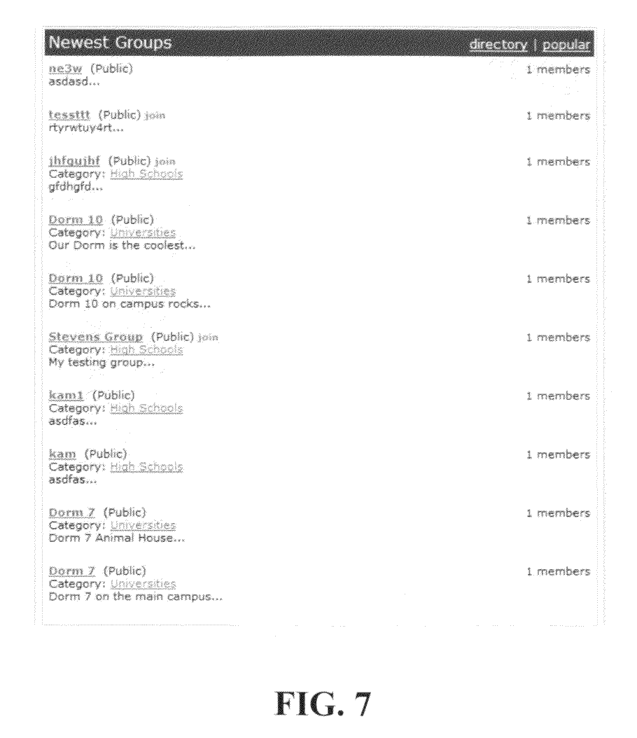

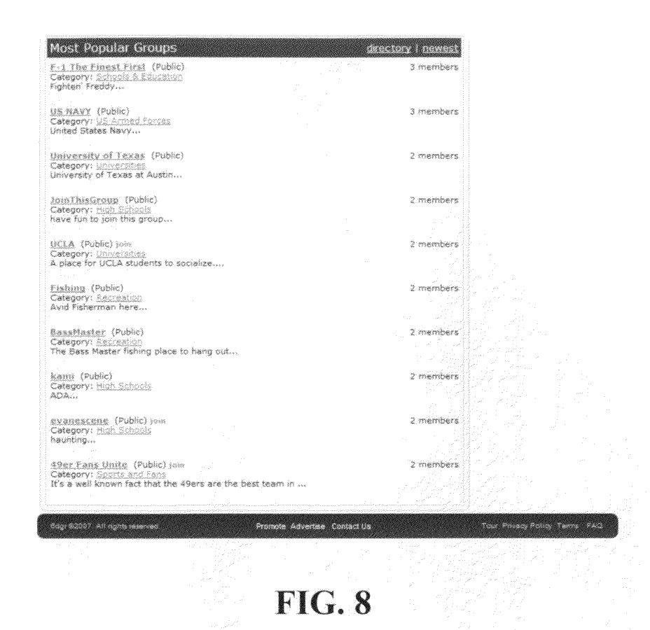

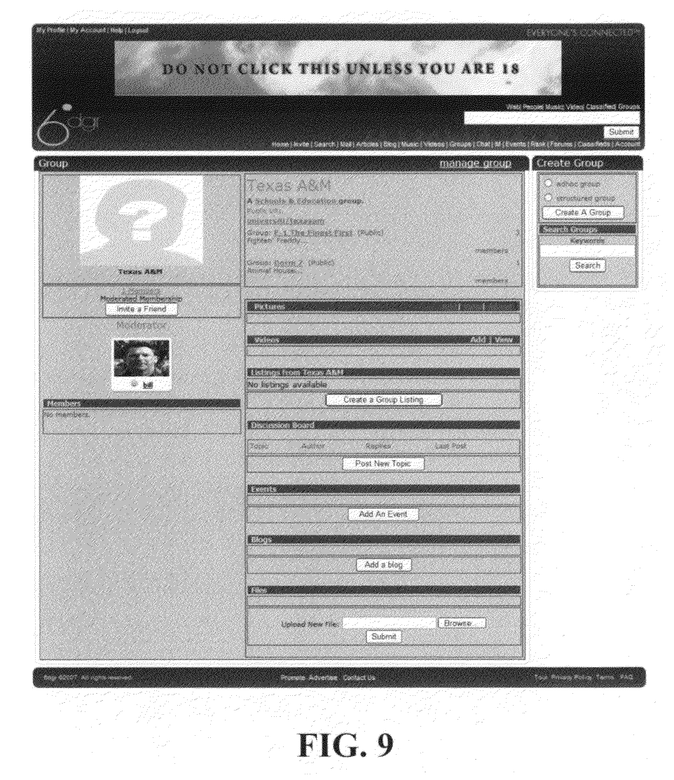

FIGS. 2-13 are screenshots from one particular, non-limiting embodiment of a website adapted to implement the networks and methodologies described herein. FIGS. 2-3 show a homepage for a particular member of the network. As seen therein, the homepage is broken into various sections, including a “welcome” section, “action items”, “My Network”, “My Photos”, “My Videos”, “Personal URL”, and “My Friends”, “My Group”, “My Subscriptions”, and “Recent Listings”. The function of these various sections is evident. The homepage also contains a bulletin board section where announcements may be posted by the network administrators. Each of these various sections may be customized by the user, and content on other pages of the website may also be customized by the user. FIG. 4 is a screenshot of a page obtained by clicking one of the thumbnails in the “My Friends” section.

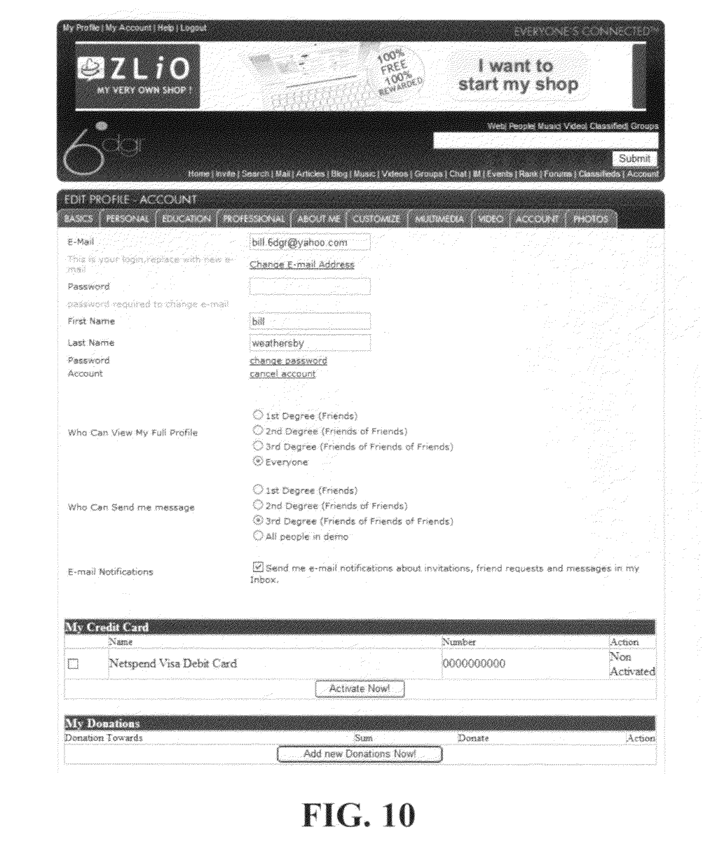

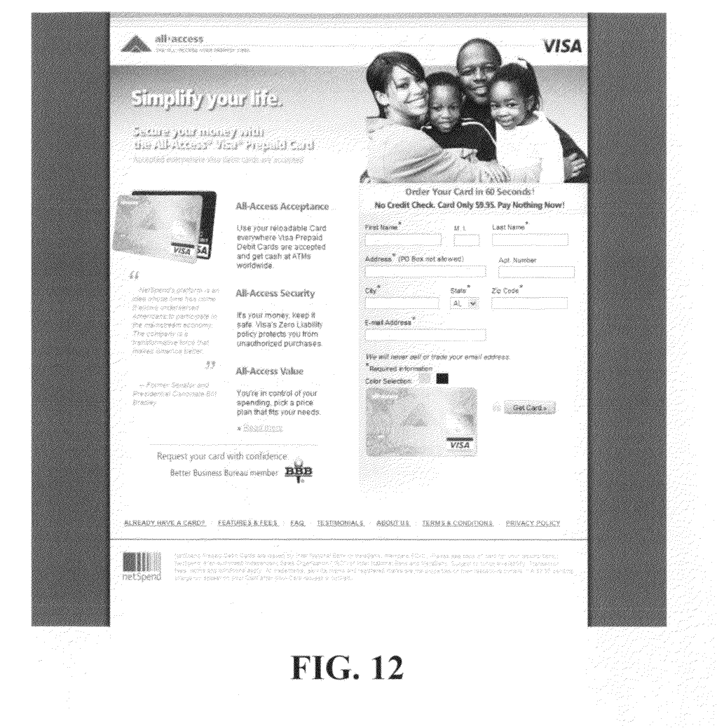

FIG. 10 is a screenshot of a page that may be navigated to by selecting the “Edit” hotlink (located next to “My Profile” in the Welcome section of the screen shown in FIG. 2). As seen therein, the page contains a table of financial instruments in the section “My Credit Card”, which is currently populated by a Visa Debit card. When the user clicks the “Activate Now” button, the user is redirected to a third party web site (shown in FIG. 12) maintained by the company managing the VISA Debit card, where the user signs up for the card (a similar procedure would be followed to sign up for other types of products or financial instruments offered through the network).

After the user signs up for the debit card, the company managing the card sends information to the website management identifying the user and providing some of the demographic and other information the user was required to provide in the application. Typically, this information will include the member who sponsored the member who applied for the debit card so that the former can be assigned a rebate. After the application is approved, the field “Number” is populated with the last four numbers of the debit card, and the field “Action” is populated with the designation “activated” to indicate that the debit card is ready to use. At this point, the user is activated on the website, and is placed into a hierarchy so that he can receive rebates for successfully soliciting subscriptions to the financial instrument.

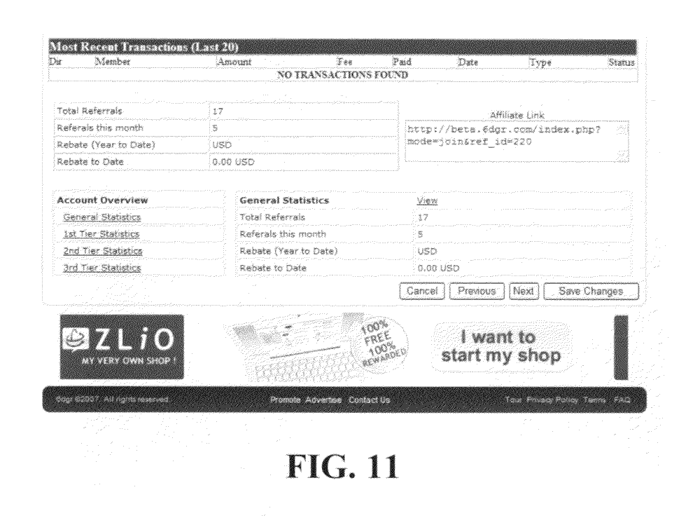

FIG. 11 is a screen shot showing the bottom part of the screen depicted in FIG. 10. As seen therein, this page contains general account information, including “Account Overview”, “General Statistics” and “Total Referrals” tables, which provide various data concerning, among other things, the number of referrals the member has made that have successfully resulted in subscriptions to a financial instrument, and the dollar amount of rebates earned.

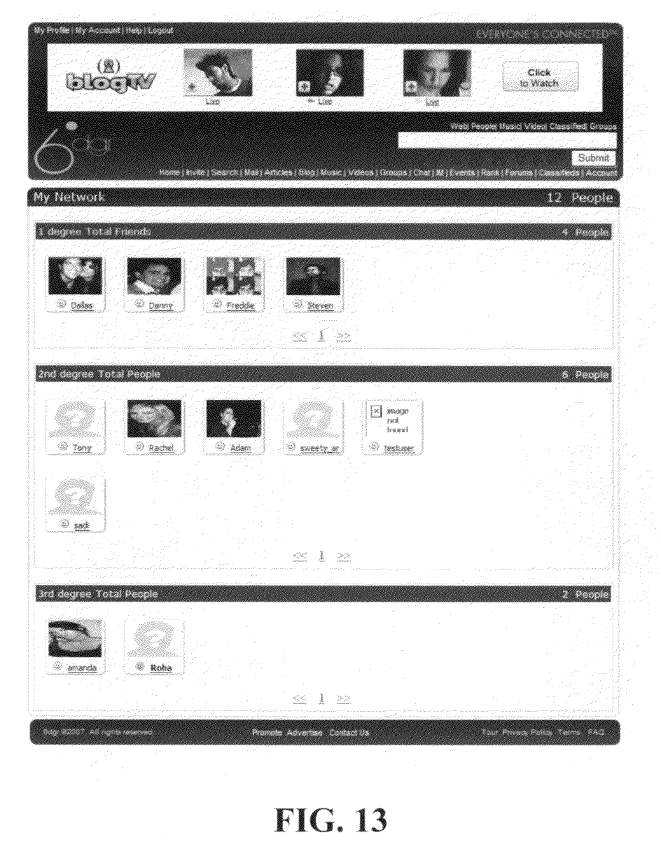

Clicking on the “general statistics” link displays a view of the user's hierarchy. By clicking on the “view” hotlink, the user can view his network (that is, the map of members to which he has ties). An example of that view is depicted in the screenshot of FIG. 13. In the nomenclature of FIG. 1, the user in FIG. 13 is member mₓ, the first degree parties shown in the screenshot of FIG. 13 are members the user has signed up to the financial instrument (members m_{xy}), the second degree parties (members m_{xyz}) are members signed up by the first degree members, and the third degree parties are members signed up by the second degree people. In one preferred embodiment, the user receives a one-time $2 rebate for every 1^{st} degree member in his hierarchy, $1 for every second degree member, and $1 for every third degree member.

As noted above, the methodologies described herein may be utilized with various products or financial instruments. As a specific further example, the managers of the website may strike an exclusive deal with a mortgage company. As a result, when a member of the network signs up for a home mortgage (again, this must happen through an existing member), a promotion code will be passed to the mortgage company. This will result in an origination fee (which may be, for example, half a point or a flat fee) being sent to the management of the network. A portion of these proceeds will be paid back against the appropriate portion of the network hierarchy in the form of rebates appearing on the VISA debit cards of the appropriate members. Thus, for example, ⅓ of the funds may be utilized as a payout in this manner, with the remaining portion being retained to offset management costs.

As noted above, third party data rights will typically exist between network management and the companies managing financial instruments sponsored by the network, so that network management can obtain certain demographic information on its members (in some embodiments, network management may handle or facilitate the signup process, and may obtain demographic information on its members that way). Since accurate information is required to sign up for these financial instruments, the information which network management obtains on its members has a high degree of accuracy. This is true even of information not specifically verified by the company managing a financial instrument, since the presence of corroborated information in an application for the financial instrument makes it highly likely that any uncorroborated information is also true.

Due to the high veracity of the information obtained in conjunction with the financial instrument, the methodology disclosed herein avoids problems encountered by many other social networks regarding multiple or false profiles. Hence, network management can provide extremely accurate profile and demographics (including, for example, household income range) to vendors interested in exclusivity or use of behavioral statistics. Moreover, since a valid email is required to open account on the network, spamming is minimized or eliminated.

In some embodiments, members of the network may be given a membership status that reflects the amount of verified information known about them. For example, a member may be given green status upon verification of their email address, gold status if any two of gender, age, address and location are verified, and platinum if all four of gender, age, address and location are verified. In some embodiments, a member's membership status may affect the amount or type of rebates available to that member.

The information available to network management about members of the network also provides unique opportunities for gathering valuable marketing information. For example, if a marketing company pays members of the network a fee in order to induce them to respond to a survey, network management can define who responded to the survey from a demographic perspective. The marketing company may then use that information to massage the results. Thus, for example, the marketing company may cull responses from members with demographic profiles that do not interest them, or may weigh the responses as a function of demographical information.

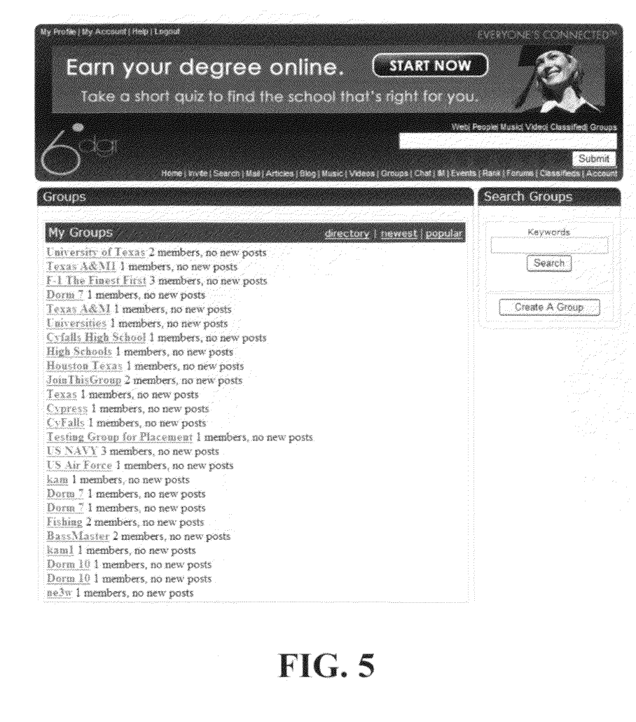

Referring now to FIG. 3 (which is the bottom portion of the web page shown in FIG. 2) and FIGS. 5-9, the network in this example contains several special interest groups. These may be centered about special interests such as politics, hobbies, sports, sports teams, alma maters, and the like. Each special interest group will typically have a portion of the website devoted to it, and will typically contain pictures, videos, blogs, discussion topics, classifieds, events, schedules, or other items of interest to that group.

Each of these special interest groups is managed by a member of the network. Members of the network have an incentive to sign up to run the special interest groups because, as groups form and members sign up for the groups, they will sign up under the member running the group. Hence, the member running the group will be building his personal network by managing the group, and will be compensated through a rebate stream derived from the group members.

One significant feature of some of the systems and methodologies described herein is that the user is empowered to develop their own personal network within the broader framework of a social network. Thus, in contrast to many existing social networks in which common interest groups are aligned at the same level and in which the users are thus arranged in “many-to-many” correspondences, the groups in the networks described herein may exist at various levels, and may create “one-to-many” correspondences. Consequently, the networks possible in accordance with the teachings herein have a richer and more complex topography than is seen in many existing social networks.

By way of example, group hierarchies may have the form

Universities/Texas A&M/Dorm 7/4^{th} Floor

or

Universities/Texas A&M/Sports/Intramural/Volleyball.

Each group or subgroup may have public or private content associated with it. Thus, for example, the 4^{th} Floor subgroup in the first example may upload a video to the network which is marked “private”, and which is only accessible to members of that group. Conversely, content may be designated “public”, and may thus be viewed by anyone browsing the group.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

### APPENDIX A

### List of Features

The following list sets forth some of the features of the systems and methodologies described herein. This list is not a claims listing.

A1. A method for marketing a product in conjunction with a network, wherein the network includes sets of members Mₙ, Mₙ₊₁ and Mₙ₊₂, wherein each member of Mₙ₊₁ has subscribed to the product through a member of Mₙ, and wherein each member of Mₙ₊₂ has subscribed to the product through a member of Mₙ₊₁, the method comprising:

providing a first rebate to a member mₓεMₙ for each member m_{xy}εSₓ that has subscribed to the product through member mₓ, wherein Sₓ⊂Mₙ₊₁; and

providing a second rebate to member mₓ for each member m_{xy}εS_{xy} that has subscribed to the product through member m_{xy}, wherein S_{xy}⊂Mₙ₊₂.

A2. The method of A1, wherein each member mₓ also subscribes to the product, and wherein the rebate is applied as a credit to a financial instrument associated with member mₓ.
A3. The method of A1, further comprising:

providing the first rebate to each member m_{xy} for each member m_{xy}εS_{xy}.

A4. The method of A1, wherein the product is selected from the group consisting of credit cards, debit cards, loans, bank accounts and insurance policies.
A5. The method of A1, wherein the product is selected from the group consisting of credit cards and debit cards.
A6. The method of A1, wherein the product is selected from the group consisting of mortgages and personal loans.
A7. The method of A1, wherein the product is selected from the group consisting of life insurance policies, homeowner's insurance policies, and health insurance policies.
A8. The method of A1, wherein the rebate is a one-time rebate associated with subscription to the product.
A9. The method of A1, wherein the product is a financial instrument selected from the group consisting of debit cards and credit cards, and wherein the rebate is a periodic rebate which is a function of purchases made with the financial instrument.
A10. The method of A1, wherein the financial instrument is selected from the group consisting of debit cards, credit cards, and loans, and wherein the rebate is a periodic rebate which is a function of interest charged on the financial instrument.
A11. The method of A1, wherein each of Mₙ, Mₙ₊₁ and Mₙ₊₂ has at least one member.
A12. The method of A1, wherein the network is a social network.
A13. The method of A1, wherein subscription to the product requires the provision of demographic information by the subscriber.
A14. The method of A13, further comprising:

selling advertising on the network to an advertiser.

A15. The method of A14, further comprising:

determining a demographic group that the advertiser is interested in exposing to an advertisement;

identifying members of the network which fall into the demographic group; and

exposing the identified members to the advertisement.

A16. The method of A15, further comprising:

monitoring the online status of the members; and

if an identified member is online, rendering the advertisement to the identified member.

A17. The method of A16, wherein monitoring the online status of the members is accomplished through the use of a login protocol.
A18. The method of A16, wherein the advertisement is rendered each time an identified member attempts to access a given web page on the network.
A19. The method of A16, wherein the advertisement is rendered periodically while an identified member is browsing a given web page on the network.
A20. The method of A13, wherein the demographic data is authenticated by a third party.
A21. The method of A20, wherein the third party is a financial institution.
A22. The method of A13, wherein the demographic information is selected from the group consisting of email address, gender, age, and physical address information.
A23. The method of A13, wherein the demographic information includes email address, gender, age, and physical address information.
A24. The method of A1, wherein the network is a social network.
A25. The method of A15, wherein the advertising is targeted only to members of the network who have subscribed to the product.
A26. The method of A14, further comprising:

receiving from the advertiser a description of a targeted demographical group the advertiser wishes to target with an advertisement.

A27. The method of A26, wherein utilizing the demographic data to target advertising to members of the network includes:

verifying that a user is online; and

using the demographic information provided by the user to determine if the user is in the targeted demographical group.

A28. The method of A27, further comprising:

displaying the advertisement to the user only if the user is in the targeted demographical group.

A29. The method of A28, further comprising displaying a generic advertisement to the user if the user is not in the targeted demographical group.
A30. The method of A28, wherein the steps of verifying and displaying occur in real time.
A31. The method of A16, wherein rendering the advertisement includes displaying the advertisement in a visual format.
A32. The method of A31, wherein the visual format is selected from the group consisting of video formats and picture formats.
A33. The method of A31, wherein the advertisement is a banner advertisement.
A34. The method of A16, wherein rendering the advertisement to the subscriber includes displaying the advertisement in an audio format.
B1. A method for marketing a product which can be subscribed to, the method comprising:

providing a network which includes first, second and third sets of members, wherein each member of the second set subscribes to the product through a member of the first set, and wherein each member of the third set subscribes to the product through a member of the second set;

providing a first rebate to a member of the first set for each member of the second set that subscribes to the product through that member of the first set; and

providing a second rebate to a member of the second set for each member of the third set that subscribes to the product through that member of the second set.

B2. The method of B1, wherein the second rebate is split between the member of the second set through whom a member of the third set subscribed to the product, and the member of the first set through whom the member of the second set subscribed to the product.
B3. The method of B1, wherein the product is a financial instrument.
C1. A method for marketing a product, comprising:

providing a network which includes a member mₓ and sets of members Mₙ₊₁ and Mₙ₊₂, wherein Mₙ₊₁ is the set of network members who have subscribed to the product through mₓ, and wherein Mₙ₊₂ is the set of network members who have subscribed to the product through a member of Mₙ₊₁; and

providing a first rebate to mₓ for each member of Mₙ₊₁, and providing a second rebate to mₓ for each member of Mₙ₊₂.

C2. The method of C1, wherein Mₙ₊₁ includes a member m_{xy}, wherein Sₙ₊₁ is the set of network members who have subscribed to the product through m_{xy}, wherein Sₙ₊₁ ⊂Mₙ₊₂, and further comprising:

providing the first rebate to m_{xy} for each member of Sₙ₊₁.

C3. The method of C2, wherein Sₙ₊₂ is the set of network members who have subscribed to the product through a member of Sₙ₊₁ and further comprising:

providing the second rebate to m_{xy} for each member of Sₙ₊₂.

C4. The method of C1, wherein the product is a financial instrument.
D1. A system for allocating rebates in conjunction with a product, comprising:

a network which includes sets of members Mₙ, Mₙ₊₁ and Mₙ₊₂, wherein each member of Mₙ₊₁ has subscribed to the product through a member of Mₙ, and wherein each member of Mₙ₊₂ has subscribed to the product through a member of Mₙ₊₁; and

a rebate allocation system which allocates rebates to members of the network such that a first rebate is allocated to a member mₓ εMₙ for each member m_{xy} εSₓ that has subscribed to the product through member mₓ, wherein Sₓ⊂Mₙ₊₁, and such that a second rebate is allocated to member mₓ for each member m_{xy}εS_{xy} that has subscribed to the product through member m_{xy} wherein S_{xy}⊂Mₙ₊₂.

D2. The system of D1, wherein the product is a financial instrument, wherein each member mₓ also subscribes to the product, and wherein the rebate is applied as a credit to the financial instrument of member mₓ.
D3. The system of D1, wherein the first rebate is allocated to each member m_{xy} for each member m_{xy}εS_{xy}.
D4. The system of D1, wherein the product is selected from the group consisting of credit cards, debit cards, loans, bank accounts and insurance policies.
D5. The system of D1, wherein the product is selected from the group consisting of credit cards and debit cards.
D6. The system of D1, wherein the product is selected from the group consisting of mortgages and personal loans.
D7. The system of D1, wherein the product is selected from the group consisting of life insurance policies, homeowner's insurance policies, and health insurance policies.
D8. The system of D1, wherein the rebate is a one-time rebate associated with subscription to the product.
D9. The system of D1, wherein the product is selected from the group consisting of debit cards and credit cards, and wherein the rebate is a periodic rebate which is a function of purchases made with the product.
D10. The system of D1, wherein the product is selected from the group consisting of debit cards, credit cards, and loans, and wherein the rebate is a periodic rebate which is a function of interest charged on the financial instrument.
D11. The system of D1, wherein each of Mₙ, Mₙ₊₁ and Mₙ₊₂ has at least one member.
D12. The system of D1, wherein the network is a social network.
D13. The system of D1, wherein subscription to the product requires the provision of demographic information by the subscriber.
D14. The system of D13, wherein the network management sells advertising on the network to advertisers, and further comprising an advertisement rendering program adapted to (a) identify members of the network which fall into a demographic group that an advertiser has targeted for an advertisement; and (b) render the advertisement to each of the identified members who is online.
D15. The system of D14, wherein the advertisement rendering software is further adapted to monitor the online status of the members.
D16. The system of D15, wherein the advertisement rendering software monitors the online status of the members by through the use of a login protocol.
D17. The system of D16, wherein the advertisement is rendered each time an identified member attempts to access a given web page on the network.
D18. The system of D16, wherein the advertisement is rendered periodically while an identified member is browsing a given web page on the network.
D19. The system of D1, wherein the rebate allocation system is a software program.
E1. A system for allocating rebates in conjunction with a financial instrument, comprising:

a network which includes first, second and third sets of members, wherein each member of the second set subscribes to the financial instrument through a member of the first set, and wherein each member of the third set subscribes to the financial instrument through a member of the second set; and

a rebate allocation system which allocates rebates to members of the network such that a first rebate is allocated to a member of the first set for each member of the second set that subscribes to the financial instrument through that member of the first set, and such that a second rebate is allocated to a member of the second set for each member of the third set that subscribes to the financial instrument through that member of the second set.

F1. A method for targeting advertising in conjunction with a network, comprising:

providing a product which can be subscribed to by members of the network, wherein subscription to the product requires the provision of authenticated demographic data pertaining to the subscribing member; and

utilizing the demographic data to target advertising to members of the network.

F2. The method of F1, wherein the demographic data is authenticated by a third party.
F3. The method of F2, wherein the third party is a financial institution.
F4. The method of F1, wherein the network is a social network.
F5. The method of F1, wherein the demographic data is selected from the group consisting of email address, gender, age, and physical address information.
F6. The method of F1, wherein the advertising is targeted only to members of the network who have subscribed to the product.
F7. The method of F1, wherein the product is a financial instrument.
F8. The method of F1, wherein the product is a debit card.
F9. The method of F1, wherein the product is a credit card.
F10. The method of F1, wherein the product is a loan.
F11. The method of F10, wherein the loan is a mortgage.
F12. The method of F10, wherein the loan is a personal loan.
F13. The method of F1, further comprising:

receiving from an advertiser a description of a targeted demographical group the advertiser wishes to target with an advertisement.

F14. The method of F13, wherein utilizing the demographic data to target advertising to members of the network includes:

verifying that a user is online; and

using the demographic information provided by the user to determine if the user is in the targeted demographical group.

F15. The method of F14, further comprising:

displaying the advertisement to the user only if the user is in the targeted demographical group.

F16. The method of F15, further comprising displaying a generic advertisement to the user if the user is not in the targeted demographical group.
F17. The method of F15, wherein the steps of verifying and displaying occur in real time.
G1. A method for targeting advertisements to users of a network, comprising:

providing a database having a plurality of advertisements associated therewith, wherein the plurality of advertisements includes a first advertisement which is targeted to a first demographic group;

assigning a fingerprint to each user, wherein each fingerprint comprises demographic information relating to the user which has been verified through a subscription to a product; and

rendering the first advertisement to users who are members of the first demographic group.

G2. The method of G1, wherein the plurality of advertisements further includes a second advertisement which is targeted to a second demographic group.
G3. The method of G2, wherein the first and second groups are distinct.
G4. The method of G2, wherein the first and second advertisements are distinct.
G5. The method of G1, further comprising:

identifying a user through a login process by which the user logs onto the network; and

determining, from the user's fingerprint, whether the user is a member of the first demographic group.

G6. The method of G1, wherein rendering the first advertisement includes periodically rendering the advertisement.
G7. The method of G1, wherein the advertisement is rendered for a predetermined amount of time.
G8. The method of G7, further comprising:

periodically determining the user's online status; and

if the user is still online, re-rendering the advertisement.

G9. The method of G1, wherein the network is a social network, and wherein the users are subscribers to the network.
G10. The method of G9, wherein the product is offered through the social network.
G11. The method of G10, wherein network management manages subscription to the product.
G12. The method of G11, wherein network management gathers demographic information as part of managing subscription to the product.
G13. The method of G12, wherein the product is a financial instrument.
G14. The method of G12, wherein the product is a credit card or a debit card.
G15. The method of G1, wherein rendering the advertisement includes displaying the advertisement in a visual format.
G16. The method of G15, wherein the visual format is selected from the group consisting of video formats and picture formats.
G17. The method of G15, wherein the advertisement is a banner advertisement.
G18. The method of G1, wherein rendering the advertisement to the subscriber includes displaying the advertisement in an audio format.
G19. The method of G1, further comprising:

monitoring the users who are actively accessing the network.

H1. A system for targeting advertisements to users of a network, comprising:

a first database having a plurality of advertisements associated therewith, wherein the plurality of advertisements includes a first advertisement which is targeted to a first demographic group;

a second database having a plurality of fingerprints associated therewith, wherein each fingerprint comprises demographic information, relating to a user of the network, which has been verified through a subscription to a product; and

an advertisement rendering system adapted to render the first advertisement to users who are members of the first demographic group.

H2. The system of H1, wherein the system further comprises a network having a plurality of users associated therewith.
H3. The system of H1, wherein the plurality of advertisements includes a second advertisement which is targeted to a second demographic group.
H4. The system of H3, wherein the first and second advertisements are distinct, and wherein the first and second demographic groups are distinct.
H5. The system of H4, wherein the software is adapted to render the second advertisement to users who are members of the second demographic group.
H6. The system of H1, further comprising a server adapted to host the network and the advertisement rendering system, wherein the server is also adapted to run the software.
H7. The system of H1, wherein the advertisement rendering system is further adapted to determine which users are members of the first demographic group.
H8. The system of H1, wherein the advertisement rendering system is further adapted to determine which users, of those users who are currently logged into the network, are members of the first demographic group.
H9. The method of H1, wherein the product is a financial instrument.
H10. The system of H1, wherein the product is selected from the group consisting of credit cards and debit cards.
H11. The system of H1, wherein the product is selected from the group consisting of credit cards, debit cards, loans, bank accounts and insurance policies.
H12. The system of H1, wherein the product is selected from the group consisting of credit cards and debit cards.
H13. The system of H1, wherein the product is selected from the group consisting of mortgages and personal loans.
H14. The system of H1, wherein the product is selected from the group consisting of life insurance policies, homeowner's insurance policies, and health insurance policies.
H15. The system of H1, wherein the network is a social network.
H16. The system of H1, wherein subscription to the product requires the provision of demographic information by the subscriber.
H17. The system of H1, wherein the network management sells advertising on the network to advertisers, and wherein the advertisement rendering system is adapted to (a) identify members of the network which fall into a demographic group that an advertiser has targeted for an advertisement; and (b) render the advertisement to each of the identified members who is online.
H18. The system of H17, wherein the advertisement rendering system is further adapted to monitor the online status of the members.
H19. The system of H18, wherein the advertisement rendering software monitors the online status of the members by through the use of a login protocol.
H20. The system of H19, wherein the advertisement is rendered each time an identified member attempts to access a given web page on the network.
H21. The system of H19, wherein the advertisement is rendered periodically while an identified member is browsing a given web page on the network.

What is claimed is:

1. A system for allocating rebates in conjunction with a product, comprising:
a network which includes sets of members Mₙ, Mₙ₊₁ and Mₙ₊₂, wherein each member of Mₙ₊₁ has subscribed to the product through a member of Mₙ, and wherein each member of Mₙ₊₂ has subscribed to the product through a member of Mₙ₊₁; and
a rebate allocation system which allocates rebates to members of the network such that a first rebate is allocated to a member mₓεMₙ for each member mₓ εSₓ that has subscribed to the product through member mₓ, wherein Sₓ⊂Mₙ₊₁, and such that a second rebate is allocated to member mₓ for each member m_{xy}εS_{xy} that has subscribed to the product through member m_{xy}, wherein S_{xy}⊂Mₙ₊₂.

2. The system of claim 1, wherein the product is a financial instrument, wherein each member mₓ also subscribes to the product, and wherein the rebate is applied as a credit to the financial instrument of member mₓ.

3. The system of claim 1, wherein the first rebate is allocated to each member m_{xy} for each member m_{xy}εS_{xy}.

4. The system of claim 1, wherein the product is selected from the group consisting of credit cards, debit cards, loans, bank accounts and insurance policies.

5. The system of claim 1, wherein the product is selected from the group consisting of credit cards and debit cards.

6. The system of claim 1, wherein the product is selected from the group consisting of mortgages and personal loans.

7. The system of claim 1, wherein the product is selected from the group consisting of life insurance policies, homeowner's insurance policies, and health insurance policies.

8. The system of claim 1, wherein the rebate is a one-time rebate associated with subscription to the product.

9. The system of claim 1, wherein the product is selected from the group consisting of debit cards and credit cards, and wherein the rebate is a periodic rebate which is a function of purchases made with the product.

10. The system of claim 1, wherein the product is selected from the group consisting of debit cards, credit cards, and loans, and wherein the rebate is a periodic rebate which is a function of interest charged on the financial instrument.

11. The system of claim 1, wherein each of Mₙ, Mₙ₊₁ and Mₙ₊₂ has at least one member.

12. The system of claim 1, wherein the network is a social network.

13. The system of claim 1, wherein subscription to the product requires the provision of demographic information by the subscriber.

14. The system of claim 13, wherein the network management sells advertising on the network to advertisers, and further comprising an advertisement rendering program adapted to (a) identify members of the network which fall into a demographic group that an advertiser has targeted for an advertisement; and (b) render the advertisement to each of the identified members who is online.

15. The system of claim 14, wherein the advertisement rendering software is further adapted to monitor the online status of the members.

16. The system of claim 15, wherein the advertisement rendering software monitors the online status of the members by through the use of a login protocol.

17. The system of claim 16, wherein the advertisement is rendered each time an identified member attempts to access a given web page on the network.

18. The system of claim 16, wherein the advertisement is rendered periodically while an identified member is browsing a given web page on the network.

19. The system of claim 1, wherein the rebate allocation system is a software program.

20. A system for allocating rebates in conjunction with a financial instrument, comprising:
a network which includes first, second and third sets of members, wherein each member of the second set subscribes to the financial instrument through a member of the first set, and wherein each member of the third set subscribes to the financial instrument through a member of the second set; and
a rebate allocation system which allocates rebates to members of the network such that a first rebate is allocated to a member of the first set for each member of the second set that subscribes to the financial instrument through that member of the first set, and such that a second rebate is allocated to a member of the second set for each member of the third set that subscribes to the financial instrument through that member of the second set.
